(19) United States
(12) Patent Application Publication
(10) Pub. No.: US 2026/0197699 A1
(43) Pub. Date: Jul. 9, 2026

(54) CONGESTION INFORMATION EXPOSURE

(71) Applicant: Lenovo (Beijing) Limited, Beijing (CN)

(72) Inventors: Haiyan Luo, Shanghai (CN); Mingzeng Dai, Shanghai (CN); Tingfang Tang, Beijing (CN)

(73) Assignee: Lenovo (Beijing) Limited, Beijing (CN)

(21) Appl. No.: 19/134,306

(22) PCT Filed: Jan. 6, 2023
(86) PCT No.: PCT/CN2023/071053

§ 371 Date: May 30, 2025

(51) Int. Cl. H04W 28/02; H04L 47/26; H04W 76/12

(52) U.S. Cl. CPC H04W 28/0268; H04L 47/26; H04W 76/12

(57) ABSTRACT

Method and apparatus for congestion information exposure are disclosed. In one embodiment, SMF comprises a processor and a transceiver coupled to the processor, wherein the processor is configured to configure, via the transceiver, a network node with QFI as well as at least one of ‘ECN or L4S marking indication’, ‘indication of identifying ECT (0) or ECT (1)’ and ‘direction of congestion exposure’ associated with the QFI.

### FIELD

The subject matter disclosed herein generally relates to wireless communications, and more particularly relates to congestion information exposure.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (UE), Extended Reality (XR), Radio Access Network (RAN), Quality of Service (QoS), Explicit Congestion Notification (ECN), Internet Protocol (IP), Low Latency, Low Loss and Scalable throughput (L4S), PDU Session Anchor (PSA), User Plane Function (UPF), general packet radio service (GPRS), GPRS Tunneling Protocol (GTP), Network Exposure Function (NEF), Application Function (AF), Session Management Function (SMF), Policy Control Function (PCF), Network Exposure Function (NEF), QoS Notification Control (QNC), XR/Media service (XRM), Transmission Control Protocol (TCP), ECN-Capable Transport (ECT), Congestion Experienced (CE), acknowledge (ACK), Congestion Window Reduced (CWR), 5G core (5GC), Policy and Charging Control (PCC), Packet Flow Description (PFD), 5G system (5GS), Packet Flow Description Function (PFDF), Data Network Name (DNN), Single Network Slice Selection Assistance Information (S-NSSAI), Unified Data Repository (UDR), Service Data Flow (SDF), QoS Flow Identifier (QFI).

For extended reality (XR) traffic and other traffics, the network congestion information is useful for the application layer to utilize the link state indications and perform codec adaptation, which accordingly further alleviates congestion and ensures desired experience for users.

This disclosure targets enhancement to congestion information exposure.

### BRIEF SUMMARY

Method and apparatus for congestion information exposure are disclosed.

In one embodiment, SMF comprises a processor and a transceiver coupled to the processor, wherein the processor is configured to configure, via the transceiver, a network node with QFI as well as at least one of ‘ECN or L4S marking indication’, ‘indication of identifying ECT(0) or ECT(1)’ and ‘direction of congestion exposure’ associated with the QFI.

In some embodiment, the processor is further configured to obtain a configuration of a flow description, the ‘ECN or L4S marking indication’, the ‘indication of identifying ECT(0) or ECT(1)’ and the ‘direction of congestion exposure’ from PCF or by pre-configuration.

In some embodiment, the network node includes RAN node, and the processor is configured to configure, via the transceiver, the RAN node with the QFI as well as the ‘ECN or L4S marking indication’ and the ‘direction of congestion exposure’ associated with the QFI. The processor may be configured to further configure, via the transceiver, the RAN node with the ‘indication of identifying ECT(0) or ECT(1)’.

In some embodiment, the network node includes UPF and RAN node, and the processor is configured to configure, via the transceiver, the UPF with the QFI as well as the ‘indication of identifying ECT(0) or ECT(1)’ associated with the QFI, and configure, via the transceiver, the RAN node with the QFI as well as the ‘ECN or L4S marking indication’ and the ‘direction of congestion exposure’ associated with the QFI.

In some embodiment, the network node includes RAN node, and the processor is configured to configure, via the transceiver, the RAN node with ‘GTP-U marking indication’ and the ‘direction of congestion exposure’. The network node may further include UPF, and the processor is configured to configure, via the transceiver, the UPF with the QFI as well as the ‘ECN or L4S marking indication’ and the ‘direction of congestion exposure’ associated with the QFI. Alternatively, the network node may further include UPF, and the processor is configured to configure, via the transceiver, the UPF with the QFI and the ‘direction of congestion exposure’, ‘congestion exposure indication’ and ‘target address for congestion exposure’ associated with the QFI.

In another embodiment, a RAN node comprises a processor and a transceiver coupled to the processor, wherein the processor is configured to obtain, via the transceiver, from SMF, QFI as well as ‘direction of congestion exposure’ and at least one of ‘ECN or L4S marking indication’ and ‘GTP-U marking indication’ associated with the QFI.

In some embodiment, the processor is further configured to, when network congestion happens, mark packets of QoS flow identified with the QFI with Congestion Experienced codepoint in IP header based on the ‘direction of congestion exposure’.

In some embodiment, the processor is further configured to obtain, via the transceiver, from SMF, ‘indication of identifying ECT(0) or ECT(1)’ associated with the QFI, and identify packets with ECT(0) or ECT(1) by reading ECN field in the IP header before performing ECN or L4S marking.

In some embodiment, the processor is further configured to contain congestion info into GTP-U extension header based on the ‘direction of congestion exposure’.

In yet another embodiment, a UPF comprises a processor and a transceiver coupled to the processor, wherein the processor is configured to obtain, via the transceiver, from SMF, QFI as well as at least one of ‘ECN or L4S marking indication’, ‘indication of identifying ECT(0) or ECT(1)’ and ‘direction of congestion exposure’ associated with the QFI.

In some embodiment, the processor is further configured to obtain, via the transceiver, from SMF, ‘congestion exposure indication’ and ‘target address for congestion exposure’ associated with the QFI.

In further embodiment, a method performed by SMF comprises configuring a network node with QFI as well as at least one of ‘ECN or L4S marking indication’, ‘indication of identifying ECT(0) or ECT(1)’ and ‘direction of congestion exposure’ associated with the QFI.

In further embodiment, a method performed by RAN node comprises obtaining, from SMF, QFI as well as ‘direction of congestion exposure’ and at least one of ‘ECN or L4S marking indication’ and ‘GTP-U marking indication’ associated with the QFI.

In further embodiment, a method performed by UPF comprises obtaining, from SMF, QFI as well as at least one of ‘ECN or L4S marking indication’, ‘indication of identifying ECT(0) or ECT(1)’ and ‘direction of congestion exposure’ associated with the QFI.

### BRIEF DESCRIPTION OF THE DRAWINGS

A more particular description of the embodiments briefly described above will be rendered by referring to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates a first embodiment;

FIG. 2 illustrates a second embodiment;

FIG. 3 illustrates a third embodiment;

FIG. 4 illustrates a fourth embodiment;

FIG. 5 illustrates a procedure shared by ECN mechanism and L4S mechanism share;

FIG. 6 is a schematic flow chart diagram illustrating an embodiment of a method;

FIG. 7 is a schematic flow chart diagram illustrating another embodiment of a method;

FIG. 8 is a schematic flow chart diagram illustrating a further embodiment of a method; and

FIG. 9 is a schematic block diagram illustrating an apparatus according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

There are mainly two options for RAN node to expose the congestion level information (per QoS flow) as shown in Table 1.

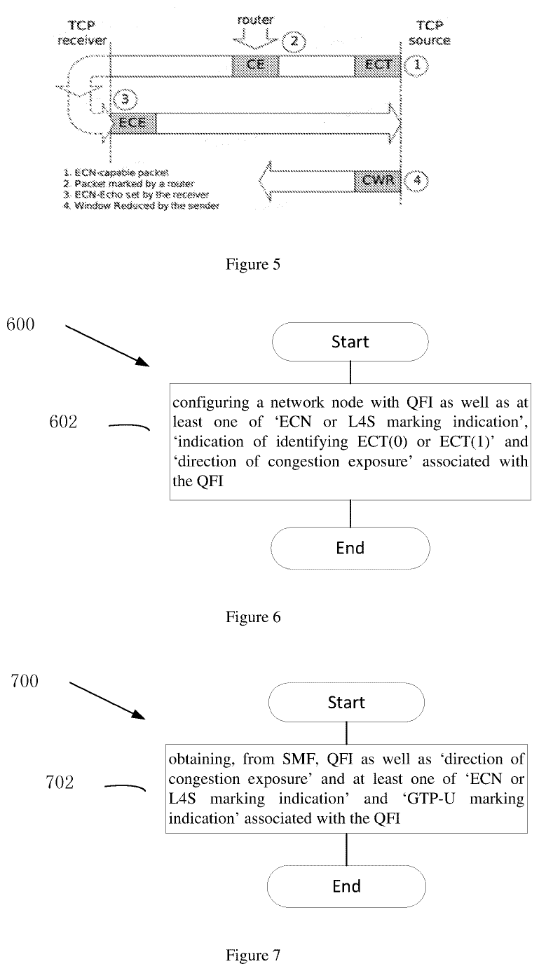

TABLE 1
agreed solutions for congestion exposure of XRM topic

| Congestion | | |
|---|---|---|
| exposure | | Details |
| Option 1 | Method1 | NG-RAN performs ECN marking for UL |
| ECN/L4S | | and DL in IP layer of the received packets. |
| mechanism | | NG-RAN is the router as shown in FIG. 5 |
| | Method2 | PSA UPF performs ECN marking for UL |
| | | and DL IP layer of the received packets |
| | | based on latest reported congestion |
| | | information from NG-RAN via |
| | | GTP-U header |
| Option 2 | User | NG-RAN provides congestion info in |
| API based | plane | GTP-U header. |
| mechanism | | Exposure path: 1)UPF => NEF => AF; |
| | | 2)UPF => SMF => PCF => NEF => AF; |
| | | (similar as QoS monitoring report) |
| | Control | 3)RAN => SMF => PCF => NEF => AF |
| | plane | (similar as QNC) |

Option 1 is related to ECN/L4S mechanism, which means ECN mechanism and L4S mechanism. The ECN mechanism and the L4S mechanism share the same procedure as shown in FIG. 5.

Step 1: TCP sender (i.e., TCP source) and TCP receiver perform negotiation over transport protocol if both TCP sender and TCP receiver are ECN (Explicit Congestion Notification) capable. The TCP sender marks ECT(0) or ECT(1) in IP header of the transmitted packets.

The IP header contains an ECN field with 2 bits, in which ‘00’ indicates “not support ECT”; ‘01’ indicates ECT(1) codepoint (i.e., L4S); ‘10’ indicates ECT(0) codepoint (i.e., ECN); and ‘11’ indicates Congestion Experienced (CE) codepoint.

Step 2: Router checks whether the packets are ECN or L4S capable. If the packet is ECN or L4S capable, router (e.g., NG-RAN node) marks UL packets in IP header with Congestion Experienced (CE) for UL congestion. It means that the router changes the ECN field in the IP header from ‘01’ or ‘10’ to ‘11’. Router marks DL packets the same way for DL congestion.

Step 3: For UL congestion, TCP receiver (i.e., App server) sends an ACK packet with ECN-Echo flag in TCP header to the TCP sender (i.e., UE). For DL congestion, TCP receiver (i.e., UE) sends an ECN-Echo response to the TCP sender (i.e., App server).

Step 4: upon receiving the ECN-Echo, the TCP sender knows that congestion happens on the path from the TCP sender to the TCP receiver.

For ECN mechanism, upon receiving the ECN-Echo (e.g., ECN Echo flag or ECN Echo response), the TCP sender can inform the TCP receiver that the congestion window has been reduced by setting the Congestion Window Reduced (CWR) flag in the TCP header.

L4S mechanism is more flexible than ECN mechanism. In L4S mechanism, router decides the ratio of packets with CE. The TCP sender will not adjust congestion window immediately upon receiving a ECN-Echo (e.g., one ECN Echo flag or one ECN Echo response). Instead, the TCP sender decides whether and how to adjust the congestion window based on the ratio of packets with ECN-Echo.

Based on ECN/L4S mechanism, PSA UPF in “Option 1 Method2” shall mark UL and/or DL packets with CE codepoint in IP header and forward the UL and/or DL packets towards Application server and/or UE. In Option 2, PSA UPF shall also inform AF of the direction of congestion, either directly via NEF or via SMF involved. Therefore, for both “Option 1 Method2” and “Option2 user plane”, both direction and congestion info shall be contained in GTP-U header. However, the packet flow may be DL dominated based on traffic characteristic. In this case, no congestion may happen for UL direction (that is, congestion only happens in DL direction). If the packet flow is UL dominated, no congestion may happen for DL direction (that is, congestion only happens in UL direction).

In addition, for both “Option 1 Method1” and “Option 1 Method2”, ECN marking for L4S is per QoS flow. In order to map a packet flow, that can be subject to ECN marking for L4S, to a QoS flow with ECN marking for L4S support, the traffic detection is performed at the UPF. For traffic detection, the packet filters can either reuse existing IP-5 tuples, or ECT(1) (i.e., ECN field value ‘01’). That is, it is not clear whether RAN node can perform traffic detection itself, i.e., whether RAN node can identify packets with ECT(1).

As a whole, the following two issues are necessary to be addressed.
Issue #1: it is still not clear whether all packets of a flow (i.e., service data flow or application flow) generated by the application are ECT(0) or ECT(1) capable or not. That is, it is required to provide a design of the opportunity that 5GC configures the packet filters with the existing IP-5 tuple and filters packets with ECT(0) or ECT(1).
Issue #2: the application may only request for DL congestion exposure or UL congestion exposure based on the traffic characteristic, which should also be indicated to UPF or RAN node in order to reduce the handling burden, e.g., checking whether the packet is ECT(0) or ECT(1) capable and further inserting CE codepoint into the IP header of the packet.

To address the above two issues, this disclosure proposes two new parameters in PCC rules. A first new parameter is ‘indication of identifying ECT(0) or ECT(1)’. A second new parameter is ‘direction of congestion exposure’. Both the first new parameter and the second new parameter are optional parameters in the PCC rules.

A first embodiment relates to SMF obtaining PCC rules including at least one of the parameters ‘ECN or L4S marking indication’, ‘indication of identifying ECT(0) or ECT(1)’ and ‘direction of congestion exposure’. The above-identified parameters can be associated with flow description (e.g., IP-5 tuple) or application identifier (AppID).

For example, when a PDU session or AF session has been established, the parameters can be associated with flow description (e.g., IP-5 tuple). When the PDU session or AF session has not been established, the parameters can be associated with the application identifier (e.g., PFD)

The description of each parameter is illustrated in Table 2.

| Associated | | |
|---|---|---|
| parameters | Flow description | AppID => PFD(s) |
| ECN or L4S | It implies that all the packets of the | It implies that all packets of the flow |
| marking indication | flow based on the flow description | based on PFD associated with |
| | are ECN capable (or L4S capable). | AppID are ECN (or L4S) capable. |
| | 5GS needs to perform ECN or L4S | 5GS needs to perform ECN or L4S |
| | marking for the flow. | marking for the flow. |
| Indication of | It implies that not all packets of the | It implies that not all packets of the |
| identifying ECT(0) | flow based on the flow description | flow based on PFD associated with |
| or ECT(1) | are ECN capable or L4S capable. | AppID are ECN capable or L4S |
| | 5GS needs to perform packet filter | capable. 5GS needs to perform |
| | to filter the packets that supports | packet filter to filter the packets that |
| | ECN or L4S mechanism. | supports ECN or L4S mechanism. |
| Direction of | It implies which direction of | It implies which direction of |
| congestion | congestion exposure is needed for | congestion exposure is needed for |
| exposure | the flow based on the flow | the flow based on PFD associated |
| | description. | with AppID. |

First, the meanings of the parameters are explained by taking an example that the parameters are associated with the flow description.

This disclosure proposes two scenarios. In a first scenario, it is assumed that all packets of a same service data flow from application server are ECN capable packets or L4S capable packets. In a second scenario, it is assumed that not all packets of a same service flow from application server are ECN capable packets or L4S capable packets.

In the first scenario, the parameter ‘ECN or L4S marking indication’ can be “ECN marking indication” or “L4S marking indication”. If the “ECN marking indication” is associated with the flow description, all the packets of the flow are ECN capable (i.e., ECN field of all the packets of the flow is ‘10’); if the “L4S marking indication” is associated with the flow description, all the packets of the flow are L4S capable (i.e., ECN field of all the packets of the flow is ‘01’). As a whole, if the flow description is associated with “ECN marking indication”, 5GS needs to perform ECN marking for the flow; and if the flow description is associated with “L4S marking indication”, 5GS needs to perform L4S marking for the flow. Incidentally, L4S marking may be also referred to as ECN marking for L4S.

In the second scenario, not all packets of a same service flow from application server are ECN capable packets or L4S capable packets. For example, the ECN fields of the packets of the flow can be ‘00’ and ‘01’, or ‘00’ and ‘10’, or ‘00’, ‘01’ and ‘10’ (in which ‘00’ indicates “not support of ECN”, ‘10’ indicates “ECT(0)”, and ‘01’ indicates “ECT(1)”). That is to say, at least one packet of the flow is configured with an ECN field of ‘00’. The parameter ‘indication of identifying ECT(0) or ECT(1)’ can be “indication of identifying ECT(0)” or “indication of identifying ECT(1)”. If the flow description is associated with the “indication of identifying ECT(0)”, 5GS needs to perform packet filtering to identify the packets with ECT(0) codepoint within the service data flow (SDF) (i.e., determine which packets are ECN capable), and then perform the congestion marking based on ECN mechanism by default or by the parameter of “ECN marking indication”; and if flow description is associated with the “indication of identifying ECT(1)”, 5GS needs to perform packet filtering to identify the packets with ECT(1) codepoint within the service data flow (SDF) (i.e., determine which the packets are L4S capable), and then perform the congestion marking based on L4S mechanism by default or by the parameter of “L4S marking indication”.

The ‘ECN or L4S marking indication’ and the ‘indication of identifying ECT(0) or ECT(1)’ can be separate two indications. Alternatively, they can be combined. In a first example, if only the ‘ECN or L4S marking indication’ is contained (which means that the ‘indication of identifying ECT(0) or ECT(1)’ is not contained), it implies that the congestion marking is required based on ECN or L4S mechanism, however it is not necessary to identify ECT(0) or ECT(1). In a second example, if only the ‘indication of identifying ECT(0) or ECT(1)’ is contained (which means that the ‘ECN or L4S marking indication’ is not contained), it implies that the congestion marking based on ECN mechanism is needed by default if “indication of identifying ECT(0)” is configured, while it implies that the congestion marking based on L4S mechanism is needed by default if “indication of identifying ECT(1)” is configured. In a third example, if both of ‘ECN or L4S marking indication’ and the ‘indication of identifying ECT(0) or ECT(1)’ (e.g., “ECN marking indication” and “indication of identifying ECT(0)”, or “L4S marking indication” and “indication of identifying ECT(1)”) are configured, it implies that the packet filtering is performed firstly to identify the packets with ECT(0) codepoint (e.g., “indication of identifying ECT(0)” is configured) or ECT(1) codepoint (e.g., “indication of identifying ECT(1)” is configured), and then the congestion marking is performed based on the “ECN marking indication” or “L4S marking indication” respectively.

The ‘direction of congestion exposure’ may indicate “DL congestion exposure”, “UL congestion exposure” or “bi-directional congestion exposure”. If the ‘direction of congestion exposure’ indicates “DL congestion exposure”, 5GS (e.g., 5GC NF or RAN node) marks the DL packets with CE codepoint in case that DL congestion happens. If the ‘direction of congestion exposure’ indicates “UL congestion exposure”, 5GS (e.g., 5GC NF or RAN node) marks the UL packets with CE codepoint in case that UL congestion happens. If the ‘direction of congestion exposure’ indicates “bi-directional congestion exposure”, 5GS (e.g., 5GC NF or RAN node) marks the UL packets or the DL packets with CE codepoint in case that UL congestion or DL congestion happen respectively.

In an alternative implementation of the parameter ‘direction of congestion exposure’, if no ‘direction of congestion exposure’ is associated with the flow description, bi-directional congestion information should be exposed if the flow description is associated with ‘ECN or L4S marking indication’ and/or ‘indication of identifying ECT(0) or ECT(1)’.

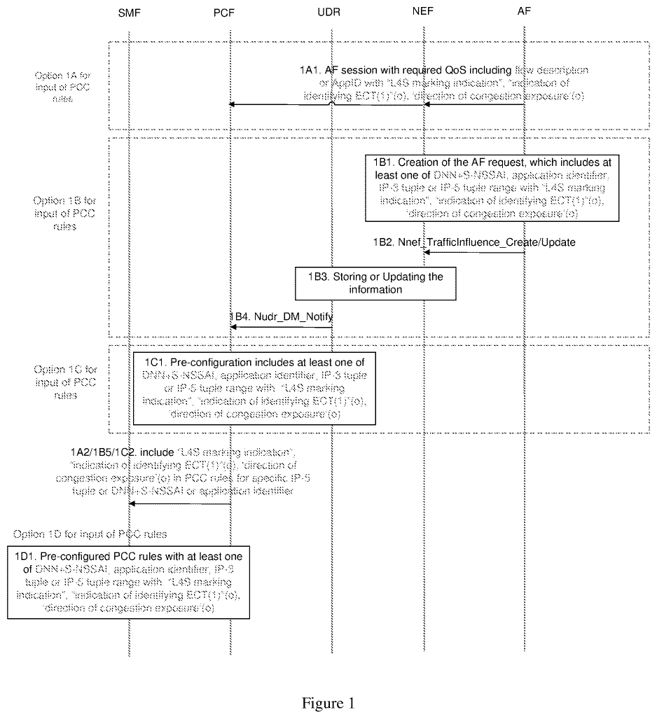

SMF can obtain the PCC rules including flow description or application identifier as well as the associated parameters (e.g., at least one of the parameters ‘ECN or L4S marking indication’, ‘indication of identifying ECT(0) or ECT(1)’ and ‘direction of congestion exposure’) by dynamic querying from PCF (option 1A, 1B or 1C in FIG. 1) or by pre-configuration in SMF (option 1D in FIG. 1). That is to say, the PCC rules are obtained from PCF while the PCC rules can be obtained by PCF from AF (option 1A or 1B) or pre-configured in PCF (option 1C). FIG. 1 illustrates the first embodiment including all of options 1A, 1B, 1C and 1D.

In a first sub-embodiment (option 1A) of the first embodiment, AF provides PCF with ‘ECN or L4S marking indication’ (which is indicated as “L4S marking indication” in FIG. 1), ‘indication of identifying ECT(0) or ECT(1)’ (which is indicated as “indication of identifying ECT(1)” in FIG. 1) and ‘direction of congestion exposure’.

In step 1A1, the AF sends a request to PCF to reserve resources for an AF session using Nnef_AFsessionWithQoS_Create request message, which includes UE address, AF Identifier, Flow description(s) or External Application Identifier (AppID) with ‘ECN or L4S marking indication’ (i.e., “L4S marking indication” in FIG. 1), ‘indication of identifying ECT(0) or ECT(1)’ (i.e., “indication of identifying ECT(1)” in FIG. 1) and ‘direction of congestion exposure’. For example, as shown in FIG. 1, “L4S marking indication” is provided, and “indication of identifying ECT(1)” and ‘direction of congestion exposure’ are optionally provided.

If the parameters are associated with the application identifier (AppID), PCF will include the application identifier (AppID) in the PCC rules.

In step 1A2, PCF provides SMF with PCC rules, which include ‘ECN or L4S marking indication’, ‘indication of identifying ECT(0) or ECT(1)’ and ‘direction of congestion exposure’ for specific IP-5 tuple or a combination of DNN and S-NSSAI (i.e., DNN+S-NSSAI) or application identifier or a combination of DNN, S-NSSAI and application identifier.

If the parameters are associated with the application identifier (AppID), SMF acquires the associated Packet Flow Description(s) (PFD) for an AppID from NEF (PFDF) when a PCC rule corresponding to this Application Identifier is provided or activated and PFDs provided by the NEF (PFDF) are not available at the SMF. Based on the mapping of PFD and AppID, SMF determines which service data flow (or application flow) 1) supports ECN/L4S mechanism, 2) needs identification of ECT(0) or ECT(1), and/or 3) requires congestion exposure for the indicated direction.

In a second sub-embodiment (option 1B) of the first embodiment, AF provides application description with ‘ECN or L4S marking indication’, ‘indication of identifying ECT(0) or ECT(1)’ and ‘direction of congestion exposure’ in a different way from option 1A.

In step 1B1, AF creates an AF request by including at least one of a combination of DNN and S-NSSAI (i.e., DNN+S-NSSAI), application identifier, IP-3 tuple or IP-5 tuple range with ‘ECN or L4S marking indication’, ‘indication of identifying ECT(0) or ECT(1)’ and ‘direction of congestion exposure’. Incidentally, IP-5 tuple range means that the IP address of the server is fixed, but the IP address of UE can be in a given IP range.

In step 1B2, AF forwards the parameters in step 1B1 towards NEF, e.g., AF may trigger Nnef_TrafficInflence_Create/Update procedure to forward the parameters.

In step 1B3, NEF stores or updates UDR with the information contained in step 1B2.

In step 1B4, UDR forwards the new or updated information to PCF e.g., by Nudr_DM_Notify procedure, which will further be included in PCC rules.

In step 1B5 that is the same as step 1A2.

In a third sub-embodiment (option 1C) of the first embodiment, PCF is preconfigured with application description associated with ‘ECN or L4S marking indication’, ‘indication of identifying ECT(0) or ECT(1)’ and ‘direction of congestion exposure’.

In step 1C1, PCF is pre-configured with at least one of a combination of DNN and S-NSSAI (i.e., DNN+S-NSSAI), application identifier, IP-3 tuple or IP-5 tuple range associated with ‘ECN or L4S marking indication’, ‘indication of identifying ECT(0) or ECT(1)’ and ‘direction of congestion exposure’.

In step 1C2 that is the same as step 1A2.

In a fourth sub-embodiment (option 1D) of the first embodiment, SMF is preconfigured with application description associated with ‘ECN or L4S marking indication’, ‘indication of identifying ECT(0) or ECT(1)’ and ‘direction of congestion exposure’.

In step 1D1, SMF is pre-configured with PCC rules including at least one of a combination of DNN and S-NSSAI (i.e., DNN+S-NSSAI), application identifier, IP-3 tuple or IP-5 tuple range associated with ‘ECN or L4S marking indication’, ‘indication of identifying ECT(0) or ECT(1)’ and ‘direction of congestion exposure’.

The main differences between ECN mechanism and L4S mechanism are (1) the time to adjust congestion window depends on one ECN-Echo (for ECN mechanism) or the ratio of packets with ECN-Echo (for L4S mechanism); and (2) the marking of congestion in the ECN field is from ‘10’ (for ECN mechanism) to ‘11’ or from ‘01’ (for L4S mechanism) to ‘11’.

It can be seen that the principle of the marking of congestion is the same (changing the ECN field to CE codepoint, i.e., ‘11’). That is, once congestion (e.g., DL congestion and/or UL congestion) happens, if ‘ECN marking indication’ is indicated or implied, the ECN field ‘10’ is changed to ‘11’; while if ‘L4S marking indication’ is indicated or implied, the ECN field ‘01’ is changed to ‘11’ for L4S capable packets with a given ratio.

In view of the above, the following description only describes L4S mechanism as an example. It is obvious that ECN mechanism can be performed similarly.

Incidentally, if the network operator wants to apply classic ECN marking, it shall guarantee that any sender (UE or Server) requesting classic ECN congestion control will not tag its packets with ECT(1), since ECT(1) will be used in L4S marking (i.e., ECN marking for L4S). It means that if L4S marking (i.e., ECN marking for L4S) is supported, any sender (UE or Server) requesting classic ECN congestion control shall tag its packets with ECT(0) and shall not tag its packets with the ECT(1). As a whole, the network operator will guarantee that if only classic ECN marking is applied, no packets are tagged with ECT(1); and if only L4S marking (i.e., ECN marking for L4S) is applied, no packets are tagged with ECT(0).

A second embodiment relates to RAN node performing L4S mechanism.

The second embodiment applies to ‘option 1 method 1’, i.e., RAN node performs L4S marking for UL and/or DL congestion in the IP header of the received packets (i.e., changing the ECN field ‘01’ to ‘11’ for the received packets if congestion happens).

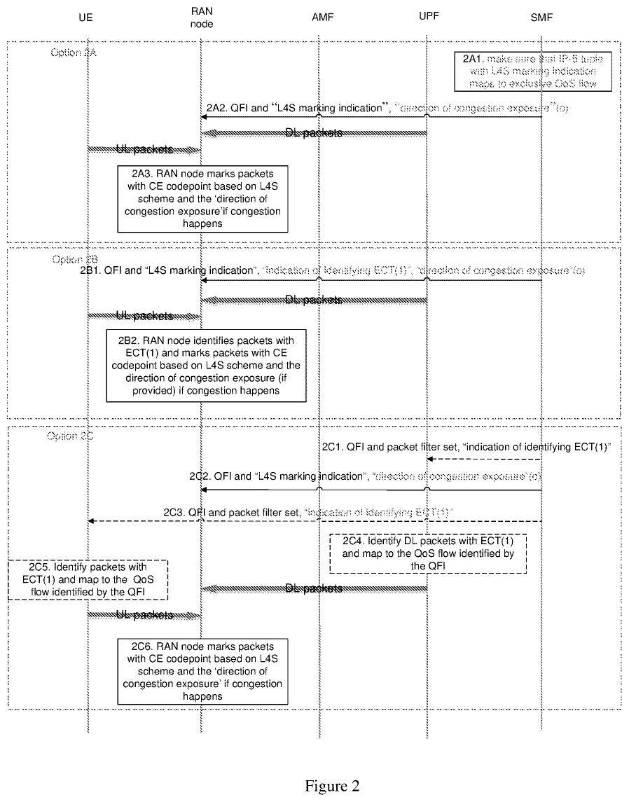

FIG. 2 illustrates three sub-embodiments (i.e., Options 2A, 2B and 2C) of the second embodiment.

In a first sub-embodiment (Option 2A) of the second embodiment, exclusive L4S QoS flow is indicated. That is, all packets of the SDF (or application flow) are L4S capable. For example, in the first embodiment, in the PCC rules obtained by or preconfigured in SMF, “L4S marking indication” is indicated or implied.

In step 2A1, SMF makes sure that only IP-5 tuples (i.e., SDFs) with “L4S marking indication” can be mapped into the same QoS flow (e.g., an exclusive QoS flow). That is, SDF(s) with L4S marking indication will not be combined with SDF(s) without such indication into a single QoS flow.

In step 2A2, SMF informs the RAN node (i.e., the RAN node that connects to the UE) to perform L4S marking, and provides the RAN node with QFI as well as the “L4S marking indication” and the ‘direction of congestion exposure’ associated with the QFI.

In step 2A3, if DL congestion happens, the RAN node marks DL packets with CE codepoint (i.e., ‘11’) in the IP header based on L4S scheme if ‘direction of congestion exposure’ indicates “DL congestion exposure” or “bi-directional congestion exposure”; if UL congestion happens, the RAN node marks UL packets with CE codepoint in the IP header based on L4S scheme if ‘direction of congestion exposure’ indicates “UL congestion exposure” or “bi-directional congestion exposure”. Incidentally, the “bi-directional congestion exposure” can be indicated by not providing the parameter ‘direction of congestion exposure’. That is to say, the bi-directional congestion exposure can be regarded as a default configuration.

In a second sub-embodiment (Option 2B) of the second embodiment, the RAN node is required to identify the packets with ECT(1). For example, the parameter ‘indication of identifying ECT(0) or ECT(1)’ indicates “indication of identifying ECT(1)”.

In step 2B1, SMF informs the RAN node to perform L4S marking, and provides the RAN node with QFI as well as the “L4S marking indication”, “indication of identifying ECT(1)” and the ‘direction of congestion exposure’ associated with the QFI.

In step 2B2, if congestion happens, the RAN node identifies the packets with ECT(1) (i.e., with ECT(1) in IP header) from the QoS flow with the QFI, and marks the identified packets (i.e., the packets with ECT(1)) packets with CE codepoint based on L4S scheme and the ‘direction of congestion exposure’). That is, if DL congestion happens, the RAN node identifies the DL packets with ECT(1), and marks the identified DL packets (i.e., the DL packets with ECT(1)) with CE codepoint (i.e., ‘11’) in the IP header based on L4S scheme if ‘direction of congestion exposure’ indicates “DL congestion exposure” or “bi-directional congestion exposure”; and if UL congestion happens, the RAN node identifies the UL packets with ECT(1), and marks the identified UL packets (i.e., the UL packets with ECT(1)) with CE codepoint (i.e., ‘11’) in the IP header based on L4S scheme if ‘direction of congestion exposure’ indicates “UL congestion exposure” or “bi-directional congestion exposure”. The “bi-directional congestion exposure” can be indicated by not providing the parameter ‘direction of congestion exposure’.

In a third sub-embodiment (Option 2C) of the second embodiment, UPF identifies DL packets with ECT(1) and maps the identified DL packets into a specific QoS flow; and UE identifies UL packets with ECT(1) and maps the identified UL packets into a specific QoS flow. For example, the parameter ‘indication of identifying ECT(0) or ECT(1)’ indicates “indication of identifying ECT(1)”.

In step 2C1, SMF provides UPF with QFI as well as packet filter set and the “indication of identifying ECT(1)” associated with the QFI, where the packet filter set can be IP packet filter set (such as IP-3 tuple or IP-5 tuple) or Ethernet packet filter set. If DL congestion exposure is supported, the “indication of identifying ECT(1)” exists in step 2C1. Otherwise, “indication of identifying ECT(1)” is not provided in step 2C1.

In step 2C2, SMF provides the RAN node with QFI as well as “L4S marking indication” and the ‘direction of congestion exposure’ (optional) associated with the QFI.

In step 2C3, SMF provides UE with QFI as well as packet filter set (such as IP-3 tuple or IP-5 tuple) and the “indication of identifying ECT(1)” associated with the QFI. If UL congestion exposure is supported, the “indication of identifying ECT(1)” exists in step 2C3. Otherwise, “indication of identifying ECT(1)” is not provided in step 2C3.

In step 2C4, if the “indication of identifying ECT(1)” is provided in step 2C1, UPF identifies DL packets based on the packet filter set received in step 2C1. If any DL packet matches the packet filter set received in step 2C1, UPF further checks whether the DL packet contains ECT(1) codepoint in the IP header. If the DL packet contains ECT(1) codepoint in the IP header, UPF maps the DL packet to a specific QoS flow and marks the DL packet with the QFI received in step 2C1.

In step 2C5, if the “indication of identifying ECT(1)” is provided in step 2C3, UE identifies UL packets based on the packet filter set received in step 2C3. If any UL packet matches the packet filter set received in step 2C3, UE further checks whether the UL packet contains ECT(1) codepoint in the IP header. If the UL packet contains ECT(1) codepoint in the IP header, UE maps the UL packet to a specific QoS flow and marks the UL packet with the QFI received in step 2C3.

In step 2C6, if congestion happens, RAN node marks UL and/or DL packets with CE codepoint based on L4S scheme and the direction of congestion exposure (if provided) for the QoS flow indicated by the QFI received in step 2C2. In particular, if DL congestion happens, the RAN node marks the DL packets in the specific QoS flow with the QFI received in step 2C3, with CE codepoint (i.e., ‘11’) in the IP header, based on L4S scheme, if ‘direction of congestion exposure’ indicates “DL congestion exposure” or “bi-directional congestion exposure”; and if UL congestion happens, the RAN node marks the UL packets in the specific QoS flow with the QFI received in step 2C3, with CE codepoint (i.e., ‘11’) in the IP header, based on L4S scheme, if ‘direction of congestion exposure’ indicates “UL congestion exposure” or “bi-directional congestion exposure”. The “bi-directional congestion exposure” can be indicated by not providing the parameter ‘direction of congestion exposure’

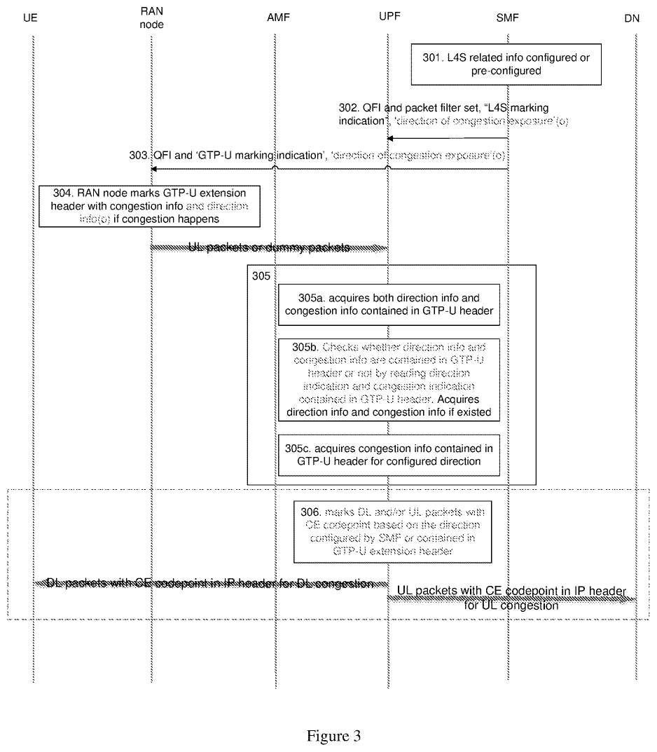

A third embodiment relates to RAN node marking GTP-U extension header applying to “option 1 method 2”. For “option 1 method 2”, PSA UPF performs ECN marking for UL and DL IP header of the received packets based on latest reported congestion information from NG-RAN via GTP-U header, where ECN marking refers to CE codepoint marking for ECN/L4S mechanism. FIG. 3 illustrates the procedure of the third embodiment.

Step 301 is the result of step 1A2 or 1B5 or 1C2 or 1D1, i.e., SMF is configured with L4S related info (that is, at least one of ‘ECN or L4S marking indication’, ‘indication of identifying ECT(0) or ECT(1)’ and ‘direction of congestion exposure’, e.g., “L4S marking indication”, “indication of identifying ECT(1)” and ‘direction of congestion exposure’), by PCF dynamically (step 1A2 or 1B5 or 1C2) or by pre-configuration (step 1D1).

In step 302, SMF provides UPF with QFI as well as packet filter set, “L4S marking indication” and ‘direction of congestion exposure’ (optional) associated with the QFI. If SMF provides UPF with the ‘direction of congestion exposure’, UPF does not need to acquire direction info from GTP-U extension header. That is, UPF acquires the direction info from SMF by control plane. If SMF does not provide UPF with the ‘direction of congestion exposure’, UPF acquires the direction info contained in GTP-U extension header provided by RAN node over user plane.

In step 303, SMF provides RAN node with QFI as well as ‘GTP-U marking indication’ and ‘direction of congestion exposure’ associated with the QFI.

In step 304, RAN node marks GTP-U extension header with congestion info and direction info (optional) if congestion happens. If the direction of congestion exposure is provided by SMF, then RAN node may only insert congestion info into the GTP-U extension header while not inserting direction info into the GTP-U extension header. Otherwise (If the direction of congestion exposure is provided by SMF), RAN node inserts both congestion info and direction info into the GTP-U extension header.

The element details of the GTP-U extension header will be described in next step 305. In step 305, UPF acquires direction info and congestion info from RAN node. As shown in FIG. 3, “UL packets and dummy packets” are sent from RAN node to UPF. The congestion info (and optionally direction info, etc) shall be carried in the GTP-U extension header of the UL packets. If no actual UL packets (from UE) are transmitted in a certain time, the RAN node may send dummy packets to carry the congestion info in the GTP-U extension header, where the dummy packets do not carry actual payload.

There are three different implementations of the elements in the GTP-U extension header. Accordingly, step 305 can be implemented as one of step 305a, step 305b and step 305c depending on the elements in the GTP-U extension header.

Based on a first implementation of the elements in the GTP-U extension header shown in Table 3, step 305 is implemented as step 305a.

TABLE 3

| | |
|---|---|
| Direction info | Congestion info |

In step 305a, RAN node provides both direction info (in direction info IE) and congestion info (in congestion info IE) in GTP-U extension header as in Table 3. UPF acquires both congestion info and direction info from the GTP-U extension header.

Direction info IE may have only one bit, e.g., “0” stands for UL and “1” stands for DL.

Alternatively, the Direction info IE may have more than one bit, e.g., two bits. For example, “01” stands for UL and “10” stand for DL, and “00” stands for no direction info provided.

Congestion info IE may have only one bit, e.g., “0” stands for no congestion and “1” stands for congestion.

Alternatively, Congestion info IE may have more than one bit, so that congestion info can be provided in finer granularity, e.g., “00” stands for no congestion, “01” stands for minor congestion, “10” stands for moderate congestion, “11” stands for high congestion.

UPF may first acquire congestion info from the congestion info IE contained in GTP-U extension header. Only if the congestion info indicates congestion, UPF further acquires the direction info.

Based on a second implementation of the elements in the GTP-U extension header shown in Table 4, step 305 is implemented as step 305b.

TABLE 4

| | | | |
|---|---|---|---|
| Direction | Congestion | Direction | Congestion |
| indication | indication | info | info |

In step 305b, RAN node indicates whether direction info and congestion info exist in GTP-U extension header or not by in-band signaling (i.e., direction indication and congestion indicated are carried in the GTP-U extension header).

UPF checks whether direction info and congestion info are contained in GTP-U header or not by reading direction indication and congestion indication contained in GTP-U extension header. The direction indication indicates whether direction info exists in GTP-U extension header. The congestion indication indicates whether congestion info exists in GTP-U extension header.

In a third implementation, it is assumed that SMF configures both UPF and RAN node with the direction of congestion exposure, where step 305 is implemented as step 305c. If DL congestion exposure is configured, RAN node marks GTP-U extension header with congestion info only when DL congestion happens. UPF marks DL packets with CE codepoint correspondingly. If UL congestion exposure is configured, RAN node marks GTP-U extension header with congestion info only when UL congestion happens. UPF marks UL packets with CE codepoint correspondingly.

In step 306, if SMF provides UPF with the ‘direction of congestion exposure’, there are three situations.

In a first scenario, SMF provides UPF with QFI and the ‘direction of congestion exposure’ that is “DL congestion exposure”. UPF marks DL packets with CE codepoint for the QoS flow identified by the provided QFI if DL congestion happens.

In a second scenario, SMF provides UPF with QFI and the ‘direction of congestion exposure’ that is “UL congestion exposure”. UPF marks UL packets with CE codepoint for the QoS flow identified by the provided QFI if UL congestion happens.

In a third scenario, SMF provides UPF with QFI and the ‘direction of congestion exposure’ that is “bi-directional congestion exposure” (or SMF does not provide UPF with the ‘direction of congestion exposure’, which implies “bi-directional congestion exposure”) UPF marks DL packets with CE codepoint for the QoS flow identified by the provided QFI if DL congestion happens. UPF also marks UL packets with CE codepoint for the QoS flow identified by the provided QFI if UL congestion happens.

If SMF does not provide UPF with the direction of congestion exposure (which does not imply “bi-directional congestion exposure”), UPF acquires both direction info and congestion info from GTP-U extension header provided by RAN node. If direction info indicates DL direction, UPF marks DL packets with CE codepoint for the QoS flow indicated by the provided QFI. If direction info indicates UL direction, UPF marks UL packets with CE codepoint for the QoS flow indicated by the provided QFI.

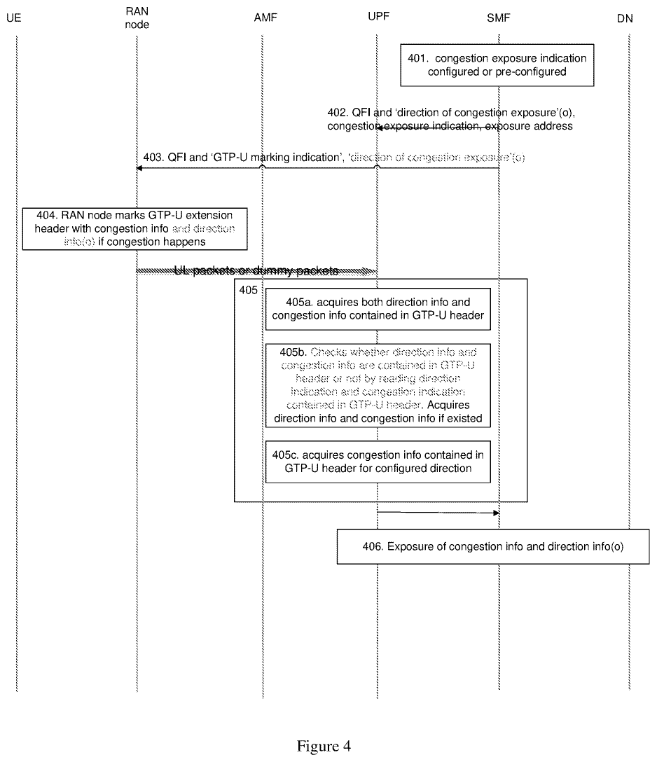

A fourth embodiment relates to RAN node marking GTP-U extension header applying to “option 2 user plane”. For “option 2 user plane”, RAN node provides congestion info in GTP-U header. FIG. 4 illustrates the procedure of the fourth embodiment.

Step 401 is similar to step 301. In step 401, SMF is configured by PCF or pre-configuration with congestion exposure indication. The congestion exposure indication will be described in step 402.

In step 402, SMF provides UPF with QFI as well as congestion exposure indication, ‘direction of congestion exposure’ (optional) and exposure address associated with the QFI. The congestion exposure indication indicates congestion information exposure is needed. The exposure address is either the address of SMF or local NEF. If the exposure address is the address of SMF, the SMF will be involved in the exposure path. For example, the exposure path is UPF=>SMF=>PCF=>NEF=>AF. If the exposure address is the address of NEF, the SMF will not be involved in the exposure path, but UPF will communicates the congestion to NEF directly. For example, the exposure path is UPF=>NEF=>AF.

In step 403, which is the same as step 303, SMF provides RAN node with QFI as well as ‘GTP-U marking indication’ and ‘direction of congestion exposure’ associated with the QFI.

Step 404 is the same as step 304. The detailed description of step 404 is omitted.

Step 405 is the same as step 305. That is, each of steps 405a, 405b, 405c is the same as each of steps 305a, 305b, 305c. The detailed description of step 405 (i.e., steps 405a, 405b, 405c) is omitted.

In step 406, UPF forwards congestion info towards the target address provided by SMF, which is either the address of SMF or the address of local NEF. If SMF provides UPF with the ‘direction of congestion exposure’ and the congestion exposure indication, there are three situations. In a first situation, if the ‘direction of congestion exposure’ is “DL congestion exposure”, UPF forwards the DL congestion info towards the target address. In a second situation, if the ‘direction of congestion exposure’ is “UL congestion exposure”, UPF forwards the UL congestion info towards the target address. In a third situation, if the ‘direction of congestion exposure’ is “bi-directional congestion exposure”, UPF forwards the DL congestion info and the direction of congestion (e.g., “DL”) towards the target address in case of DL congestion, and forward the UL congestion info and the direction of congestion (e.g., “UL”) towards the target address in case of UL congestion. In a fourth situation, if SMF provides UPF with the congestion exposure indication only (which implies that “bi-directional congestion exposure” is indicated), UPF forwards the DL congestion info and the direction of congestion (e.g., “DL”) towards the target address in case of DL congestion, and forward the UL congestion info and the direction of congestion (e.g., “UL”) towards the target address in case of UL congestion.

FIG. 6 is a schematic flow chart diagram illustrating an embodiment of a method 600 according to the present application. In some embodiments, the method 600 is performed by a network function such as an SMF. In certain embodiments, the method 600 may be performed by a processor executing program code, for example, a microcontroller, a microprocessor, a CPU, a GPU, an auxiliary processing unit, a FPGA, or the like.

The method 600 may comprise: 602 configuring a network node with QFI as well as at least one of ‘ECN or L4S marking indication’, ‘indication of identifying ECT(0) or ECT(1)’ and ‘direction of congestion exposure’ associated with the QFI.

In some embodiment, the method further comprises obtaining a configuration of a flow description, the ‘ECN or L4S marking indication’, the ‘indication of identifying ECT(0) or ECT(1)’ and the ‘direction of congestion exposure’ from PCF or by pre-configuration.

In some embodiment, the network node includes RAN node, and the method comprises configuring the RAN node with the QFI as well as the ‘ECN or L4S marking indication’ and the ‘direction of congestion exposure’ associated with the QFI. The method may further comprise configuring the RAN node with the ‘indication of identifying ECT(0) or ECT(1)’.

In some embodiment, the network node includes UPF and RAN node, the method comprises configuring the UPF with the QFI as well as the ‘indication of identifying ECT(0) or ECT(1)’ associated with the QFI, and configuring the RAN node with the QFI as well as the ‘ECN or L4S marking indication’ and the ‘direction of congestion exposure’ associated with the QFI.

In some embodiment, the network node includes RAN node, and the method comprises configuring the RAN node with ‘GTP-U marking indication’ and the ‘direction of congestion exposure’. The network node may further include UPF, and the method comprises configuring the UPF with the QFI as well as the ‘ECN or L4S marking indication’ and the ‘direction of congestion exposure’ associated with the QFI. Alternatively, the network node may further include UPF, and the method comprises configuring the UPF with the QFI and the ‘direction of congestion exposure’, ‘congestion exposure indication’ and ‘target address for congestion exposure’ associated with the QFI.

FIG. 7 is a schematic flow chart diagram illustrating an embodiment of a method 700 according to the present application. In some embodiments, the method 700 is performed by a network node such as a RAN node. In certain embodiments, the method 700 may be performed by a processor executing program code, for example, a microcontroller, a microprocessor, a CPU, a GPU, an auxiliary processing unit, a FPGA, or the like.

The method 700 may comprise 702 obtaining, from SMF, QFI as well as ‘direction of congestion exposure’ and at least one of ‘ECN or L4S marking indication’ and ‘GTP-U marking indication’ associated with the QFI.

In some embodiment, the method further comprises, when network congestion happens, marking packets of QoS flow identified with the QFI with Congestion Experienced codepoint in IP header based on the ‘direction of congestion exposure’.

In some embodiment, the method further comprises obtaining, from SMF, ‘indication of identifying ECT(0) or ECT(1)’ associated with the QFI, and identifying packets with ECT(0) or ECT(1) by reading ECN field in the IP header before performing ECN or L4S marking.

In some embodiment, the method further comprises containing congestion info into GTP-U extension header based on the ‘direction of congestion exposure’.

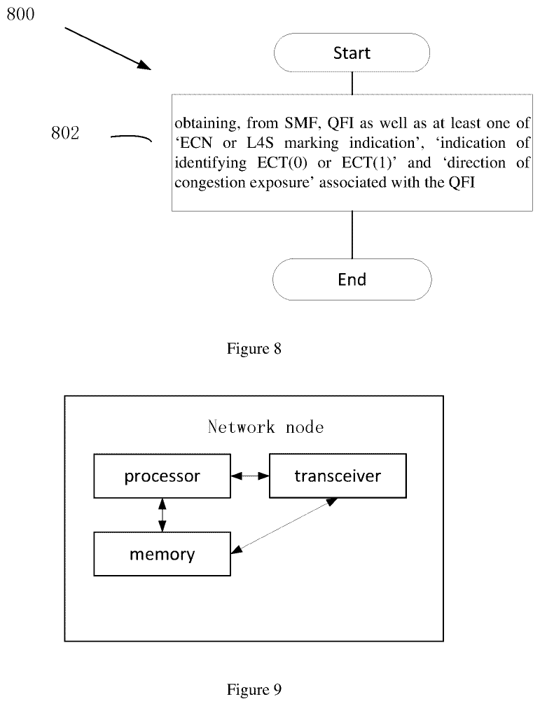

FIG. 8 is a schematic flow chart diagram illustrating an embodiment of a method 800 according to the present application. In some embodiments, the method 800 is performed by a network node such as a UPF. In certain embodiments, the method 800 may be performed by a processor executing program code, for example, a microcontroller, a microprocessor, a CPU, a GPU, an auxiliary processing unit, a FPGA, or the like.

The method 800 may comprise 802 obtaining, from SMF, QFI as well as at least one of ‘ECN or L4S marking indication’, ‘indication of identifying ECT(0) or ECT(1)’ and ‘direction of congestion exposure’ associated with the QFI.

In some embodiment, the method further comprises obtaining ‘congestion exposure indication’ and ‘target address for congestion exposure’ associated with the QFI.

FIG. 9 is a schematic block diagram illustrating apparatuses according to one embodiment.

The network function or network node or network entity (e.g., SMF or RAN node or UPF) includes a processor, a memory, and a transceiver. The processor implements a function, a process, and/or a method which are proposed in FIG. 6 or 7 or 8.

SMF comprises a processor and a transceiver coupled to the processor, wherein the processor is configured to configure, via the transceiver, a network node with QFI as well as at least one of ‘ECN or L4S marking indication’, ‘indication of identifying ECT(0) or ECT(1)’ and ‘direction of congestion exposure’ associated with the QFI.

In some embodiment, the processor is further configured to obtain a configuration of a flow description, the ‘ECN or L4S marking indication’, the ‘indication of identifying ECT(0) or ECT(1)’ and the ‘direction of congestion exposure’ from PCF or by pre-configuration.

In some embodiment, the network node includes RAN node, and the processor is configured to configure, via the transceiver, the RAN node with the QFI as well as the ‘ECN or L4S marking indication’ and the ‘direction of congestion exposure’ associated with the QFI. The processor may be configured to further configure, via the transceiver, the RAN node with the ‘indication of identifying ECT(0) or ECT(1)’.

In some embodiment, the network node includes UPF and RAN node, and the processor is configured to configure, via the transceiver, the UPF with the QFI as well as the ‘indication of identifying ECT(0) or ECT(1)’ associated with the QFI, and configure, via the transceiver, the RAN node with the QFI as well as the ‘ECN or L4S marking indication’ and the ‘direction of congestion exposure’ associated with the QFI.

In some embodiment, the network node includes RAN node, and the processor is configured to configure, via the transceiver, the RAN node with ‘GTP-U marking indication’ and the ‘direction of congestion exposure’. The network node may further include UPF, and the processor is configured to configure, via the transceiver, the UPF with the QFI as well as the ‘ECN or L4S marking indication’ and the ‘direction of congestion exposure’ associated with the QFI. Alternatively, the network node may further include UPF, andthe processor is configured to configure, via the transceiver, the UPF with the QFI and the ‘direction of congestion exposure’, ‘congestion exposure indication’ and ‘target address for congestion exposure’ associated with the QFI.

A RAN node comprises a processor and a transceiver coupled to the processor, wherein the processor is configured to obtain, via the transceiver, from SMF, QFI as well as ‘direction of congestion exposure’ and at least one of ‘ECN or L4S marking indication’ and ‘GTP-U marking indication’ associated with the QFI.

In some embodiment, the processor is further configured to, when network congestion happens, mark packets of QoS flow identified with the QFI with Congestion Experienced codepoint in IP header based on the ‘direction of congestion exposure’.

In some embodiment, the processor is further configured to obtain, via the transceiver, from SMF, ‘indication of identifying ECT(0) or ECT(1)’ associated with the QFI, and identify packets with ECT(0) or ECT(1) by reading ECN field in the IP header before performing ECN or L4S marking.

In some embodiment, the processor is further configured to contain congestion info into GTP-U extension header based on the ‘direction of congestion exposure’.

A UPF comprises a processor and a transceiver coupled to the processor, wherein the processor is configured to obtain, via the transceiver, from SMF, QFI as well as at least one of ‘ECN or L4S marking indication’, ‘indication of identifying ECT(0) or ECT(1)’ and ‘direction of congestion exposure’ associated with the QFI.

In some embodiment, the processor is further configured to obtain, via the transceiver, from SMF, ‘congestion exposure indication’ and ‘target address for congestion exposure’ associated with the QFI.

Layers of a radio interface protocol may be implemented by the processors. The memories are connected with the processors to store various pieces of information for driving the processors. The transceivers are connected with the processors to transmit and/or receive message or information. Needless to say, the transceiver may be implemented as a transmitter to transmit the information and a receiver to receive the information.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

What is claimed is:

1-14. (canceled)

15. A session management function (SMF) for wireless communication, comprising:
at least one memory; and
at least one processor coupled with the at least one memory and operable to cause the SMF to:
configure a network node with:
a quality of service (QoS) flow indicator (QFI) of a QoS flow; and
at least one of an explicit congestion notification (ECN) or a low latency, low loss and scalable throughput (L4S) marking indication, an indication of identifying ECN-capable transport (ECT), or a direction of congestion exposure associated with the QFI.

16. The SMF of claim 15, wherein the at least one processor is operable to cause the SMF to obtain a configuration for one or more of a flow description, or the ECN or the L4S marking indication.

17. The SMF of claim 16, wherein the configuration is obtained from a policy control function (PCF).

18. The SMF of claim 15, wherein the at least one processor is operable to cause the SMF to:
configure a radio access network (RAN) node with the QFI.

19. The SMF of claim 15, wherein the at least one processor is operable to cause the SMF to:
configure a radio access network (RAN) node with one or more of the ECN or L4S marking indication, or the direction of congestion exposure associated with the QFI.

20. The SMF of claim 15, wherein the at least one processor is operable to cause the SMF to:
configure a radio access network (RAN) node with one or more of a general packet radio service (GPRS) tunneling protocol (GTP) user plane (GTP-U) marking indication or the direction of congestion exposure associated with the QFI.

21. The SMF of claim 15, wherein the at least one processor is operable to cause the SMF to:
map one or more service data flows (SDFs) with an L4S marking indication into a first QoS flow.

22. The SMF of claim 21, wherein one or more SDFs without an L4S marking indication are not combined into the first QoS flow.

23. A method performed by a session management function (SMF), the method comprising:
configuring a network node with:
a quality of service (QoS) flow indicator (QFI) of a QoS flow; and
at least one of an explicit congestion notification (ECN) or a low latency, low loss and scalable throughput (L4S) marking indication, an indication of identifying ECN-capable transport (ECT), or a direction of congestion exposure associated with the QFI.

24. The method of claim 23, further comprising:
obtaining a configuration for one or more of a flow description, or the ECN or the L4S marking indication.

25. The method of claim 23, further comprising:
configuring a radio access network (RAN) node with the QFI.

26. The method of claim 23, further comprising:
configuring a radio access network (RAN) node with one or more of the ECN or L4S marking indication, or the direction of congestion exposure associated with the QFI.

27. The method of claim 23, further comprising:
configuring a radio access network (RAN) node with one or more of a general packet radio service (GPRS) tunneling protocol (GTP) user plane (GTP-U) marking indication or the direction of congestion exposure associated with the QFI.

28. The method of claim 23, further comprising:
mapping one or more service data flows (SDFs) with an L4S marking indication into a first QoS flow.

29. The method of claim 28, wherein one or more SDFs without an L4S marking indication are not combined into the first QoS flow.

30. A radio access network (RAN) node for wireless communication, comprising:
at least one memory; and
at least one processor coupled with the at least one memory and operable to cause the RAN node to:
obtain a quality of service (QoS) flow indicator (QFI);
obtain a direction of congestion exposure associated with the QFI; and
obtain at least one of an explicit congestion notification (ECN) or a low latency, low loss and scalable throughput (L4S) marking indication, or a general packet radio service (GPRS) tunneling protocol (GTP) user plane (GTP-U) marking indication associated with the QFI.

31. The RAN node of claim 30, wherein the at least one processor is operable to cause the RAN node to:
mark packets in a QoS flow identified with the QFI with a congestion experienced codepoint in an internet protocol (IP) header and based at least in part on the direction of congestion exposure associated with the QFI.

32. The RAN node of claim 31, wherein the at least one processor is operable to cause the RAN node to mark the packets based at least in part on detecting network congestion.

33. The RAN node of claim 30, wherein the at least one processor is operable to cause the RAN node to:
include congestion information in a GTP-U extension header and based at least in part on the direction of congestion exposure associated with the QFI.

34. A method performed by a radio access network (RAN) node, the method comprising:
obtaining a quality of service (QoS) flow indicator (QFI);
obtaining a direction of congestion exposure associated with the QFI; and
obtaining at least one of an explicit congestion notification (ECN) or a low latency, low loss and scalable throughput (L4S) marking indication, or a general packet radio service (GPRS) tunneling protocol (GTP) user plane (GTP-U) marking indication associated with the QFI.
